(19) United States
(12) Patent Application Publication
(10) Pub. No.: US 2025/0201916 A1
(43) Pub. Date: Jun. 19, 2025

(54) METHOD FOR ACTIVATING SOLID POLYMER ELECTROLYTE FOR USE IN SOLID-STATE POLYMER BATTERY

(71) Applicant: Battelle Memorial Institute, Richland, WA (US)

(72) Inventors: Lili Shi, Richland, WA (US); Hongliang Xu, Richland, WA (US); Jie Xiao, Richland, WA (US); Dongping Lu, Richland, WA (US)

(73) Assignee: Battelle Memorial Institute, Richland, WA (US)

(21) Appl. No.: 18/981,164

(22) Filed: Dec. 13, 2024

Related U.S. Application Data
(60) Provisional application No. 63/610,232, filed on Dec. 14, 2023.

(51) Int. Cl. H01M 10/0565; H01M 4/04; H01M 10/052; H01M 10/60

(52) U.S. Cl. CPC H01M 10/0565; H01M 4/0404; H01M 10/052; H01M 10/60; H01M 2300/0082

(57) ABSTRACT

Disclosed herein is a method for activating a solid polymer electrolyte (SPE) to facilitate making and using a solid-state polymer battery that can be operated at room temperature. The activation method disclosed herein comprises exposing the SPE to activating conditions that facilitate converting the SPE into an activated SPE that exhibits improved properties relative to the SPE prior to activation. The activated SPE can be used in solid-state polymer batteries that exhibit improved performance at room temperature. The SPE can be activated separately from any battery in which it is used, or it can be activated after having been combined with components of the battery.

### CROSS REFERENCE TO RELATED APPLICATION

This application claims the benefit of and priority to the earlier filing date of U.S. Provisional Application No. 63/610,232, filed Dec. 14, 2023, which is incorporated by reference herein in its entirety.

### ACKNOWLEDGMENT OF GOVERNMENT SUPPORT

This invention was made with Government support under Contracts DEAC025CH11231, DEAC0298CH10886, and DEAC0576RL01830 awarded by the U.S. Department of Energy. The Government has certain rights in the invention.

### FIELD

The present disclosure concerns polymer-containing solid-state batteries and methods for activating polymer-containing solid-state batteries.

### BACKGROUND

Polymer-containing solid-state batteries are promising energy storage technologies because of their safety and ease of processing compared with commercial lithium (Li)-ion batteries and other solid-state batteries. However, conventional polymer-containing solid-state batteries typically require high operating temperatures (e.g., heating at temperatures well above ambient temperature), which consumes energy and complicates cell/pack design. And, heating such batteries complicates the design and implementation of battery systems. There exists a need for polymer-based solid-state batteries that can operate at ambient temperature (and/or temperatures below ambient temperature) without deleteriously impacting other performance parameters, such as ionic conductivity and interfacial resistance.

### SUMMARY

Disclosed herein is a method for activating a solid polymer electrolyte (SPE) for use in a solid-state polymer battery, the method comprising exposing the SPE to activating conditions selected from i) heat and pressure, or (ii) sonication to produce an activated SPE, wherein the activated SPE exhibits a higher ambient temperature ionic conductivity than the SPE prior to activation.

Also disclosed herein are embodiments of an all-solid-state polymer battery, comprising: a cathode; an anode; and an activated solid polymer electrolyte (SPE), wherein the activated SPE has been activated according to any or all of the above embodiments.

Also disclosed is a method for activating a solid polymer electrolyte (SPE) for use in a solid-state polymer battery, the method comprising: exposing the SPE to a temperature ranging from a temperature higher than 40° C. to a temperature of 100° C. and a pressure ranging from 0.5 MPa to 10 MPa, to produce an activated SPE; and allowing the SPE to cool to ambient temperature prior to operating any solid-state polymer to which the SPE is added, wherein the activated SPE exhibits a higher ambient temperature ionic conductivity than the SPE prior to activation.

Also disclosed is an activated solid polymer electrolyte (SPE) comprising an alkali salt and a polymer component, wherein the activated SPE is free of crystalline regions and that exhibits an ambient temperature ionic conductivity that is three to ten times higher than an ambient temperature ionic conductivity exhibited by an untreated SPE having the alkali salt and polymer component as the activated SPE.

The foregoing and other objects, features, and advantages of the present disclosure will become more apparent from the following detailed description, which proceeds with reference to the accompanying figures.

### BRIEF DESCRIPTION OF THE DRAWINGS

FIG. 1 is an X-ray diffraction (XRD) pattern obtained from evaluating a pristine solid polymer electrolyte (also referred to herein as an “untreated” SPE) and activated SPEs that were pressed and exposed to heat at different temperatures.

FIG. 2 is a differential scanning calorimetry (DSC) thermogram showing results obtained from analyzing an untreated SPE and activated SPEs that were pressed and exposed to heat at different temperatures.

FIG. 3 is a schematic illustration showing how grain boundaries of an SPE can be reduced using an activation method according to aspects of the present disclosure.

FIGS. 4A-4E are backscattered electron (BSE) images of an untreated SPE (FIG. 4A) and activated SPEs (FIGS. 4B-4E) that were pressed and heated at various temperatures.

FIG. 5 is a schematic illustration of a polymer-containing solid-state lithium (Li)-ion battery which illustrates the Lit transport paths in an all-solid-state battery.

FIG. 6 is a schematic illustration of an exemplary activation treatment used for activating an SPE according to aspects of the method disclosed herein.

FIGS. 7A-7D show results obtained from analyzing performance for solid-state batteries comprising SPEs after having been pressed and exposed to heat at various temperatures, including activating temperatures as described herein; FIG. 7A shows results after exposing an SPE to a heating protocol combined with charge/discharge cycles, specifically showing the first charge and discharge profiles of the solid-state battery comprising the SPE pressed and heated at different temperatures (40° C.-100° C.) and 0.1 C; FIG. 7B shows results after pressing and exposing an SPE to heat at 30° C. combined with charge/discharge cycles, specifically showing the first charge and discharge profiles of a solid-state battery comprising the SPE at 0.02 C; FIG. 7C shows cycling performance of a solid-state LiFePO₄ (LFP) |SPE|Li battery operated at ambient temperature and 0.02 C, the battery comprising an untreated SPE; and FIG. 7D shows results after pressing and exposing an SPE to a heating protocol without any charge/discharge cycles.

FIG. 8 shows thermograms for polyethylene oxide (PEO) and an untreated SPE after performing thermogravimetric analysis.

FIGS. 9A-9F show scanning electron microscopy (SEM) images of an untreated SPE (FIGS. 9A and 9B), and SEM images of SPEs that were exposed to activating conditions according to the present disclosure, using different temperatures and a pressure applied from treating the SPEs after being placed inside a cell (FIGS. 9C-9F); the inserted images are digital images of the SPEs.

FIGS. 10A and 10B show XRD patterns of a PEO film and lithium bis(trifluoromethane)sulfonimide (LiTFSI) (FIG. 10A) and a differential scanning calorimetry (DSC) thermogram of PEO (FIG. 10B).

FIG. 11 is a schematic illustration of the preparation process for untreated and activated SPEs.

FIG. 12 shows XRD patterns of SPEs that have been activated at 80° C. using various pressures.

FIG. 13 shows ambient temperature-electrochemical impedance spectra (EIS) of an untreated SPE and activated SPEs that were pressed and exposed to heat at different temperatures, wherein the insert at the right top of FIG. 13 shows a zoomed-in view of the spectra and the insert at the left top of FIG. 13 presents the equivalent circuit diagram used for fitting, where Rₛ represents the system resistance, R_{b} represents the bulk resistance, C_{b} represents the constant phase element (CPE) of bulk resistance, and C_{d} represents the CPE of the diffusion resistance.

FIGS. 14A and 14B show thickness changes of SPEs that were pressed and exposed to a heat treatment (FIG. 14A) and ambient temperature-cycling performances at 0.02 mA cm⁻² of Li|Li symmetric cells using an untreated SPE and SPEs heated at 80° C. (FIG. 14B).

FIG. 15 shows the ambient temperature ionic conductivities of an untreated SPE and activated SPEs.

FIGS. 16A-16D show ambient temperature-EIS spectra (FIG. 16A) and fitting results (FIG. 16B, wherein the insert shows the equivalent circuit diagram used for fitting and where Rᵢ represents the interfacial resistance, and Cᵢ represents the CPE of the interfacial resistance) of Li anode|SPE|Li anode symmetric cells, wherein the SPE was activated at 80° C.; and ambient temperature-EIS (FIG. 16C) and fitting results (FIG. 16D) of LFP cathode|SPE|LFP cathode symmetric cells, wherein the SPE was heated at 80° C. (squares represent the experimental results, and the lines represent the fitting results).

FIG. 17 shows normalized ambient temperature-resistance of an untreated SPE and a spacer|SPE|spacer cell comprising an activated SPE that was heated at 80° C.

FIGS. 18A-18D show a breakdown diagram of estimated cell resistance of a LFP|SPE|Li full cell (FIG. 18A); fitting results of ambient temperature EIS measured in LFP|SPE|Li full cell (FIG. 18B); the 10th, 50th, and 100th charge and discharge profiles of LFP|SPE|Li full cells operated at ambient temperature and at 0.02 C, wherein the activated SPE was heated at 80° C. (FIG. 18C); and ambient temperature (0.02 C) cycling performances of LFP|SPE|Li full cells, wherein the activated SPE was heated at 80° C. (FIG. 18D).

FIGS. 19A and 19B show the coulombic efficiency of activated LFP|SPE|Li full cells cycled at ambient temperature and 0.02 C (FIG. 19A) and the 10th, 50th, 100th, and 200th charge and discharge profiles of a LFP|SPE|Li full cell operated at ambient temperature and 0.02 C, wherein the activated SPE was heated at 100° C. (FIG. 19B).

FIGS. 20A-20C show ambient temperature EIS spectra (FIG. 20A) and fitting results (FIG. 20B) of LFP|SPE|Li full cells activated using different pressure and temperature conditions, wherein the squares represent the experimental results, and the lines represent the fitting results and the insert in FIG. 20A shows the equivalent circuit diagram used for fitting; FIG. 20C shows the 0.02 C-2^{nd} cycle charge and discharge profiles of the LFP|SPE|Li full cells activated at various pressure and temperature conditions.

### DETAILED DESCRIPTION

### I. Overview of Terms

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, molarities, voltages, capacities, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing aspects of the disclosure from discussed prior art, the numbers are not approximates unless the word “about” is recited.

Although the operations of some of the aspects of the disclosure are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “introduce,” “flow,” or “provide” to describe the disclosed methods. These terms are high-level abstractions of the actual operations that are performed. The actual operations that correspond to these terms may vary depending on the particular implementation and are readily discernible by one of ordinary skill in the art.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Directions and other relative references (e.g., inner, outer, upper, lower, etc.) may be used to facilitate discussion of the drawings and principles herein, but are not intended to be limiting. For example, certain terms may be used such as “inside,” “outside,” “top,” “down,” “interior,” “exterior,” and the like. Such terms are used, where applicable, to provide some clarity of description when dealing with relative relationships, particularly with respect to the illustrated aspects of the disclosure. Such terms are not, however, intended to imply absolute relationships, positions, and/or orientations. For example, with respect to an object, an “upper” part can become a “lower” part simply by turning the object over. Nevertheless, it is still the same part and the object remains the same.

In order to facilitate review of the various aspects of the disclosure, the following explanations of specific terms are provided:

Amorphous: Non-crystalline, having no or substantially no (e.g., less than 10% or less than 5%, or less than 2.5% of the surface area of the material) molecular lattice structure. Amorphous SPEs according to the present disclosure lack a definite crystalline structure as evidenced by evaluating the SPE morphology using techniques known in the art, such as backscattered electron imaging (BSE), X-ray diffraction (XRD), differential scanning calorimetry (DSC), or combinations thereof.

Capacity: The capacity of a cell is the amount of electrical charge a cell can deliver. The capacity is typically expressed in units of mAh, or Ah, and indicates the maximum constant current a cell can produce over a period of one hour. For example, a cell with a capacity of 100 mAh can deliver a current of 100 mA for one hour or a current of 5 mA for 20 hours.

Cathode: An electrode through which electric charge flows out of a polarized electrical device. From an electrochemical point of view, positively charged cations invariably move toward the cathode and/or negatively charged anions move away from it to balance the electrons arriving from external circuitry. In a discharging battery or galvanic cell, the cathode is the positive terminal, toward the direction of conventional current. This outward charge is carried internally by positive ions moving from the electrolyte to the positive cathode, where they may be reduced. When the battery is recharged, the cathode becomes the negative terminal where electrons flow out and metal atoms (or cations) are oxidized.

Cell: As used herein, a cell refers to an energy storage device used for generating a voltage or current from a chemical reaction, or the reverse in which a chemical reaction is induced by a current. Examples include voltaic cells, electrolytic cells, and fuel cells, among others. A battery typically includes one or more cells and can be used to refer to a single-cell construct unless indicated otherwise.

Coin cell: A small, typically circular-shaped battery. Coin cells are characterized by their diameter and thickness. For example, a type 2325-coin cell has a diameter of 23 mm and a height of 2.5 mm.

Coulombic efficiency (CE): The efficiency with which charges are transferred in a system facilitating an electrochemical reaction. CE may be defined as the amount of charge exiting the battery during the discharge cycle divided by the amount of charge entering the battery during the charging cycle.

Current density: A term referring to the amount of current per unit area. Current density is typically expressed in units of mA/cm².

Electrode Active Material: A material (e.g., an element, an ion, an organic compound, or an inorganic compound) that is capable of forming redox pairs having different oxidation and reduction states (e.g., ionic species with differing oxidation states or a metal cation and its corresponding neutral metal atom). Conversions between chemical energy and electricity energy occur with an accompanying change in oxidation state these ions or compounds.

Electrolyte: A substance containing free ions that behaves as an electrically conductive medium. Electrolytes for solid-state batteries described in the present disclosure typically are solid in form. An electrolyte in contact with the anode, or negative half-cell, may be referred to as an anolyte, and an electrolyte in contact with the cathode, or positive half-cell, may be referred to as a catholyte. The anolyte and catholyte are often referred to as the negative electrolyte and positive electrolyte, respectively, and these terms can be used interchangeably.

Membrane: A membrane is a thin, pliable sheet of synthetic or natural material. A permeable membrane has a porous structure that permits ions and small molecules to pass through the membrane. Some membranes are selective membranes, through which certain ions or molecules with particular characteristics pass more readily than other ions or molecules.

Polymer: A molecule of repeating structural units (e.g., monomers) formed via a chemical reaction.

Pouch cell: A pouch cell is a battery completely, or substantially completely, encased in a flexible outer covering, e.g., a heat-sealable foil, a fabric, or a polymer membrane. The term “flexible” means that the outer covering is easy to bend without breaking; accordingly, the outer covering can be wrapped around the battery components. The electrical contacts generally comprise conductive foil tabs that are welded to the electrode and sealed to the pouch material. Because a pouch cell lacks an outer hard shell, it is flexible and weighs less than conventional batteries.

Separator: A battery separator is a porous sheet or film placed between the anode and cathode. It prevents physical contact between the anode and cathode while facilitating ionic transport.

Solid state: Composed of solid components.

Specific capacity: A term that refers to capacity per unit of mass. Specific capacity may be expressed in units of mAh/g.

### II. Introduction

Conventional solid-state batteries typically require heating to reach or maintain operational temperatures above ambient temperatures to provide suitable ionic conductivity within polymer-containing solid-state electrolytes, and/or to overcome interfacial resistance between electrode active materials and the polymer-containing solid-state electrolytes. Without these high operational temperatures, polymer-based solid-state batteries exhibit low ionic conductivity and/or high interfacial resistance between electrode active material and the polymer electrolyte. However, heating complicates the design and implementation of battery systems. Heating can also increase rates of side reactions and may lead to potential safety issues, such as thermal runaway. Thus, there is a need for polymer-based solid-state batteries that can operate at lower temperatures, particularly at ambient temperature or temperatures below ambient temperature.

In some instances, ionic conductivity of polymer electrolyte materials can be increased by introducing cross-linking oligomers and tuning the polymer's backbone and/or including inorganic fillers, plasticizers, and ionic liquids within the polymer electrolyte material. Despite these attempts to improve ionic conductivity in conventional materials, cell performance remains poor at ambient temperature and temperatures below ambient temperature.

To address these issues and other drawbacks associated with conventional solid-state polymer batteries, the present inventors have developed a method for activating a solid polymer electrolyte (SPE) which facilitates using solid-state batteries comprising the activated SPE at ambient temperatures (e.g., temperatures at or below 30° C.) or temperatures below ambient temperature. The activation method disclosed herein comprises exposing the SPE to activating conditions that facilitate converting the SPE into an activated SPE that exhibits improved properties relative to the SPE prior to activation (referred to herein as an “untreated SPE” or “pristine SPE”). The activated SPE can be used in solid-state polymer batteries that exhibit improved performance at room temperature. The SPE can be activated separately from any battery in which it is used, or it can be activated after having been combined with components of the battery. In some aspects, the activated SPE additionally, or alternatively, exhibits lower room-temperature interfacial or overall impedance than the SPE prior to activation according to the method disclosed herein. In some aspects, batteries comprising the activated SPE have a higher room-temperature specific capacity than a cell comprising an untreated SPE.

### III. Method

Disclosed herein is a method for activating an SPE to facilitate ambient temperature-operation (or low-temperature operation) of solid-state polymer batteries comprising the activated SPE. According to aspects of the disclosure, the method comprises exposing the SPE to activating conditions to produce the activated SPE. Activating conditions according to the present disclosure are distinct from, and not equivalent to, any direct heating that is used when operating conventional solid-state polymer batteries. As such, activating conditions according to the present disclosure are not equivalent to high temperature conditions that are conventionally used to operate a solid-state polymer battery. The activated SPE according to the present disclosure exhibits a higher ambient temperature ionic conductivity compared to the SPE prior to activation (that is, an untreated SPE).

In some aspects, the activating conditions comprise exposing the SPE to heat and pressure. In such aspects, heating the SPE comprises exposing the SPE to a temperature ranging from a temperature greater than 40° C. to a temperature of 100° C., such as 41° C. to 100° C., or 45° C. to 100° C., or 50° C. to 100° C., or 55° C. to 100° C., or 60° C. to 100° C., or 65° C. to 100° C., or 70° C. to 100° C., or 75° C. to 100° C., or 80° C. to 100° C., or 85° C. to 100° C., or 90° C. to 100° C., or 95° C. to 100° C. In particular aspects, heating comprises exposing the SPE to a temperature ranging from 50° C. to 90° C., such as 60° C. to 80° C. In representative aspects, the method comprises heating the SPE at a temperature of 60° C. or 80° C. In yet some other aspects, heating can comprise exposing the SPE to microwave radiation using a radiation source at a frequency of 2 to 3 GHZ, with a power of 300 to 2000 W and for a time period ranging from greater than 0 minutes to 30 minutes. When the activating conditions comprise heating (either through heat or microwave radiation) and applying pressure, the pressure applied ranges from 0.1 MPa to 10 MPa, such as 0.1 MPa to 8 MPa, or 0.1 MPa to 6 MPa, or 0.1 MPa to 5 MPa, or 0.1 MPa to 4 MPa, or 0.1 MPa to 3 MPa, or 0.1 MPa to 2 MPa, or 0.1 MPa to 1 MPa. In some aspects, the pressure can be a pressure that is applied from containing the SPE in a solid-state battery. In particular aspects, a pressure of 0.5 MPa to 1 MPa is used. In some aspects, heating and applying pressure are performed simultaneously. In yet other aspects, heating and applying pressure are performed sequentially. In some aspects, the activating conditions comprise exposing the SPE to sonication using a frequency of 30 kHz to 100 MHz for greater than 0 minutes to 30 minutes.

The activating conditions can be applied to the SPE alone or they can be applied to a combination of components comprising the SPE. For example, in some aspects, the SPE can individually be exposed to the activating conditions to provide the activated SPE, which can then be combined with one or more other components needed to complete forming a solid-state battery. In yet other aspects, the SPE can be combined with such components first and then exposed to the activating conditions. In some such aspects, the SPE is combined with an electrode active material and then activated. In yet other such aspects, the SPE is combined with a pre-formed anode or a pre-formed cathode and then activated. In yet additional aspects, the SPE is added to a constructed cell (e.g., a coin cell or pouch cell or plurality thereof) and then activated. In aspects where the SPE is independently exposed to the activating conditions that comprise heating and pressure, the SPE can be positioned between two spacers and compressed using a suitable mechanism for applying pressure. In aspects where the SPE is added to a cell and then activated using heating and pressure, the cell can be exposed to external pressure (such as by using a hot press) to facilitate exposing the SPE to pressure.

The activating conditions can be applied for a suitable time period to facilitate activating the SPE. In some aspects, the time period is at least greater than 15 minutes. In some aspects the time period ranges from greater than 15 minutes to several hours (e.g., 24 hours or less). In some representative aspects, the time period ranges from greater than 15 minutes to 4 hours or less, such as 20 minutes to 3.5 hours, or 20 minutes to 3 hours, or 20 minutes to 2.5 hours, or 20 minutes to 2 hours, or 20 minutes to 1.5 hours, or 20 minutes to 1 hour, or 20 minutes to 40 minutes.

In some aspects, the method can further comprise cooling the activated SPE prior to its use in a solid-state battery. Cooling can be achieved by using an affirmative cooling procedure (e.g., exposing the activated SPE to an environment that is cooler than the heating environment) or by removing the SPE from any heat source used to facilitate heating the SPE. In some aspects, the activated SPE is allowed to cool to ambient temperature, such as a temperature ranging from 25° C. to 35° C., such as 25° C. to 30° C. In some aspects, the activated SPE can be cooled and then added to a solid-state battery. In yet other aspects, the activated SPE can be cooled while present in a solid-state battery. Any cooling can take place over a cooling period that ranges from a few minutes to 24 hours or longer, such as 1 to 24 hours.

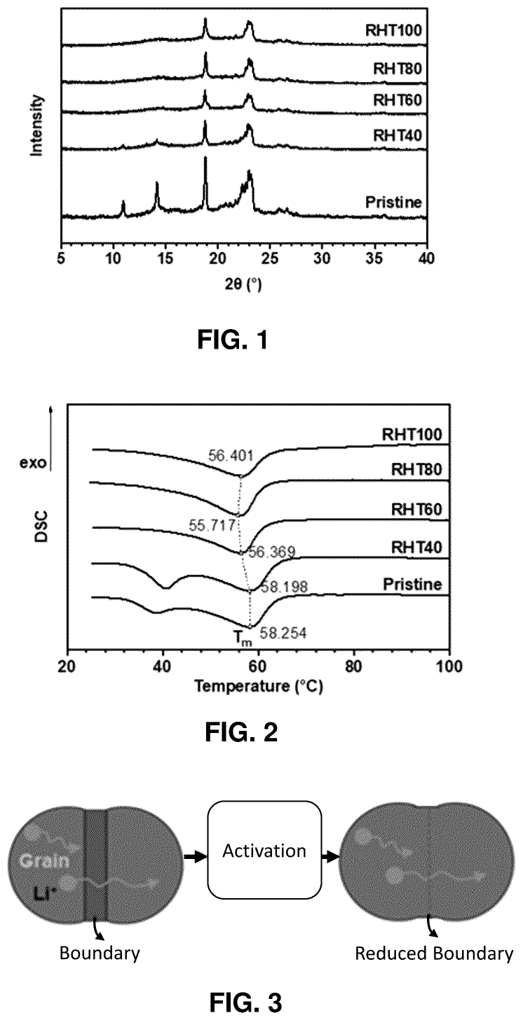

Without being limited to a single operational theory, it currently is believed that the SPE is converted to an activated form that exhibits different morphological features and/or physical properties compared to the SPE prior to being exposed to the activating conditions according to the disclosed method. In some aspects, the disclosed method facilitates converting the SPE to an activated SPE which exhibits fewer crystalline phases than the untreated SPE. To determine whether the activated SPE comprises fewer crystalline phases than the untreated SPE, a technique known to those in the art, with the benefit of the present disclosure, can be used to assess and compare the morphology of the SPE and the activated SPE (and/or components thereof, such as the polymer and/or alkali salt component). Such techniques can include, but are not limited to, backscattered electron imaging (BSE), differential scanning calorimetry (DSC), X-ray diffraction (XRD), or a combination thereof. Exemplary XRD patterns and DSC thermograms illustrating a reduction in crystalline phases upon exposing an SPE to activating conditions according to the disclosed method are shown in FIGS. 1 and 2, respectively.

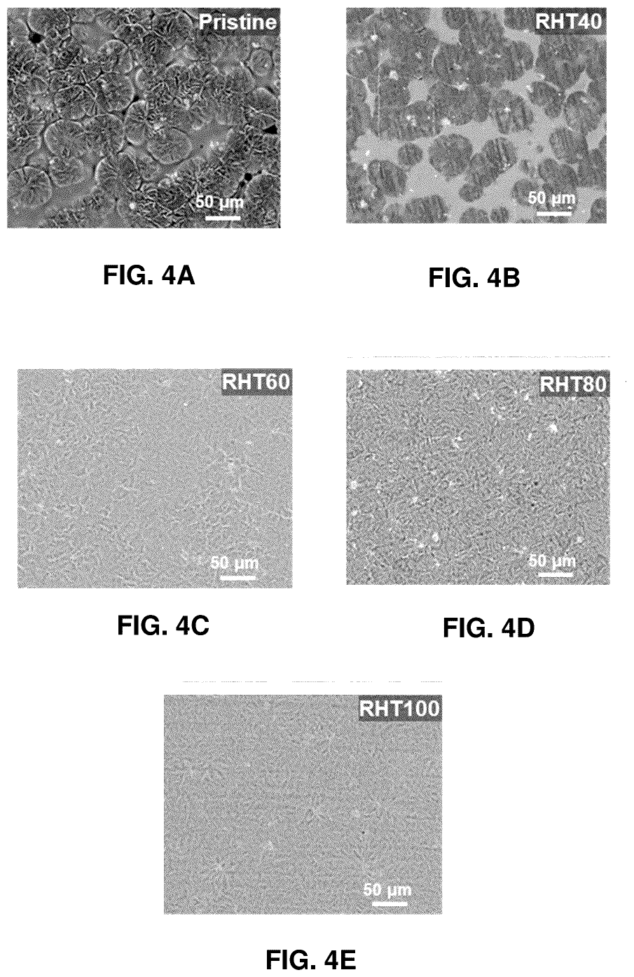

In some aspects, the disclosed method facilitates converting the SPE to an activated SPE which exhibits fewer grain boundaries than the untreated SPE. Techniques known to those in the art, with the benefit of the present disclosure, can be used to assess whether grain boundaries have been reduced in an SPE exposed to activating conditions described herein. For example, BSE can be used to assess whether distinct grain boundaries between spherulites (or other ordered patterns) within the untreated SPE have been reduced (e.g., merged together) in the activated SPE. FIG. 3 provides a schematic illustration of decreasing grain boundaries using the disclosed activation method. Exemplary BSE images illustrating a reduction in grain boundaries upon exposing an SPE to activating conditions according to the disclosed method are shown in FIGS. 4A-4E, wherein FIG. 4A shows a BSE images of an untreated SPE and FIGS. 4B-4E show images of the SPE after exposure to various temperatures and illustrating the reduction of grain boundaries as the temperature is increased above 40° C.

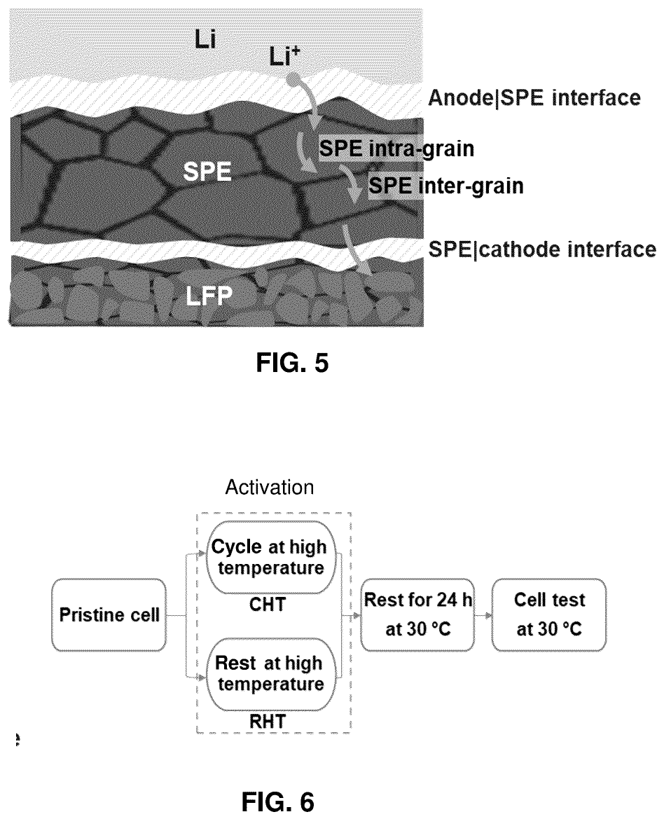

The method disclosed herein also facilitates providing an SPE that exhibits increased interfacial contact with an electrode active material used in solid-state batteries comprising the SPE, relative to an SPE that has not be activated by the disclosed method. FIG. 5 is a schematic illustration of the components of an all-solid-state Li-ion battery (ASSLB) and illustrates the various interfaces involved during operation. Li⁺ transport paths are indicated by arrows included in FIG. 5. As illustrated in FIG. 5, Lit transport within an ASSLB involves intricate bulk and interfacial steps. For example, Li⁺ ions may traverse an interface between a metallic Li anode material (“Li”) and a SPE material (“SPE”) (labeled as “anode|SPE interface” in FIG. 5), an interface between two or more grains of the SPE material (“SPE inter-grain”), an interface within a grain of the SPE material (“SPE intra-grain”), an interface between the SPE material and a cathode material (“SPE|cathode interface”), or any combination thereof. Each of these transport steps can influence Li-ion conductivity and cell reaction kinetics. As such, improving the ease of Lit transport through one or more of these boundaries, such as the SPE|electrode active material interface (which can include the SPE|cathode and/or SPE|anode interface) using the activation method according to the present disclosure can facilitate operating solid-state batteries at ambient temperature or temperatures below ambient temperature. An increase in interfacial contact between an SPE and an electrode active material can be evaluated using techniques known to those in the art with the benefit of the present disclosure. In some aspects, the level of interfacial contact between an activated SPE and an electrode active material can be assessed by measuring resistance of a cell comprising the activated SPE and the electrode active material. This can then be compared with resistance of a similar cell comprising an untreated SPE and the electrode active material. Typically, a decrease in resistance indicates an increase in interfacial contact. In some aspects, a cell comprising an activated SPE can exhibit a resistance that is less than one-tenth of that exhibited by a cell comprising an untreated SPE.

### IV. Activated SPE Material and Cell/Battery Comprising the Same

An activated SPE material is also disclosed herein. The activated SPE material is made according to a method as described herein. The activated SPE material comprises a polymer component and an alkali salt component. In some aspects, the polymer component can be a polymer selected from polyethylene oxide (PEO), poly(ethylene oxide) methyl ether methacyrlate (PEOMA), poly(acetyl-oligo (ethylene oxide) acrylate (PAEOA), polyacrylonitrile, polymethyl methacrylate, polyacrylate, polycarbonate, polyvinylidene fluoride, or any combination thereof. In particular aspects, the polymer component is polyethylene oxide. In some aspects, the alkali salt is a lithium salt, a magnesium salt, a sodium salt, or a combination thereof. In some aspects, the alkali salt is selected from lithium bis(trifluoromethane)sulfonimide (Li(CF₃SO₂)₂N) (or LiTFSI), lithium perchlorate (LiClO₄), lithium hexafluorophosphate (LiPF₆), lithium bis(fluorosulfonyl)imide (LiCF₃SO₃) (LIFSI), lithium bis(pentafluoroethanesulfonyl)imide (Li(C₂F₅SO₂)₂N) (LiBETI), lithium trifluoromethanesulfonate (LiCF₃SO₃) (LiTf), lithium bis(oxalato)borate (LiB(C₂O₄)₂) (LiBOB), lithium difluoro (oxalato) borate (LiBF₂(C₂O₄)) (LiODFB), lithium nitrate (LiNO₃), lithium iodide (LiI), sodium perchlorate (NaClO₄), sodium bis(trifluoromethanesulfonyl)imide (NaTFSI), magnesium bis(trifluoromethanesulfonimide) (Mg(TFSI)₂), or any combination thereof. In particular aspects, the alkali salt is LiTFSI.

In yet additional aspects, the activated SPE can comprise a metal oxide material, a metal sulfide material, a metal halide material, or any combination thereof, to provide an SPE composite. In such aspects, the SPE can include a combination of the polymer, the alkali salt component, and the metal oxide/sulfide/halide material (or a combination of a metal oxide, a metal sulfide, and/or a metal halide material). Suitable metal oxide/sulfide/halide materials are known to those in the art with the benefit of the present disclosure. Representative metal oxide/sulfide/halide materials can include Al₂O₃, TiO₂, CuO, garnet type oxides (e.g., Li₇La₃Zr₂O₁₂ (LLZO) with dopants of Ta, Nb, Al, Ga, etc), perovskite-type oxides (e.g., Li₃ₓLa_{2/3-x}TiO₃ (LLTO)), NASICON-type phosphates (e.g., Li₁₊ₓAlₓTi₂₋ₓ(PO₄)₃ₓ (LATP), Li₁₊ₓAlₓGe₂₋ₓ(PO₄)₃ (LAGP)), lithium phosphorus oxynitride (LiPON), Li₃PS₄, Li₆PS₅X (wherein X is Cl, Br, or I), Li₃MX₆ (wherein M is In, Y, Er, Mg, or another metal and X is Cl, Br, or I). In aspects where the SPE comprises a metal oxide/sulfide/halide material, the polymer can be present in an amount ranging from 1 wt % to 80 wt %, such as 10 wt % to 80 wt %, or 20 wt % to 80 wt % based on the weight of the SPE composite.

In some aspects, the polymer component can be modified to further enhance performance of the SPE and/or a solid-state battery comprising the SPE when operated at ambient temperature or temperatures below ambient temperature. For example, the polymer can be structurally modified (e.g., adding/modifying functional groups that branch from the polymer backbone) and/or the polymer can be blended with other materials, such as plasticizers and/or ionic liquids. Suitable plasticizers can include, but are not limited to, polythiazyl, ethyl cellulose, polyacrylic acid, or poly(methyl methacrylate). Ionic liquids suitable as additives are known in the art, particularly with the benefit of the present disclosure. In some examples, the ionic liquid is (PYR₁₄) TFSI. Methods for modifying polymer structure are known to those in the art, particularly with the benefit of the present disclosure.

In particular aspects, the activated SPE material has an amorphous morphology and is free of crystalline phases. Whether an activated SPE material is free of crystalline phases can be determined by examining the untreated SPE material to identify peaks from a DSC thermogram corresponding to crystalline phases and then evaluating whether such peaks are present or absent in the activated SPE material. In particular aspects, the amorphous state of the activated SPE does not undergo recrystallization to any crystalline phases after activating conditions have been removed.

In additional aspects, the activated SPE can exhibit a higher ambient temperature ionic conductivity than the untreated SPE. In some aspects, the activated SPE can exhibit an ambient temperature ionic conductivity value that is three to ten times higher than an ambient temperature ionic conductivity value of the untreated SPE. In such aspects, the increased ambient temperature ionic conductivity exhibited by the activated SPE can also be achieved for SPEs that include other additives, such as a metal oxide/sulfide/halide component, a plasticizer, an ionic liquid, or a combination thereof. In such aspects, the relative increase in ambient temperature ionic conductivity is made with reference to an untreated SPE that includes the same additive as the activated SPE, in the same amounts. Without being limited to a single theory, it currently is believed that the activated SPE exhibits a higher ambient temperature ionic conductivity due to decreases in grain boundary resistance that result from the activating conditions used in the method according to the disclosure. In some aspects, the activated SPE can comprise LiTFSI and PEO in combination with an oxide, in which case the activated SPE exhibits an ambient temperature ionic conductivity ranging from 1E-7 S/cm to 1E-5 S/cm. In some other aspects, the activated SPE can comprise an alkali salt in and a polymer other than PEO, such as PEOMA, PAEOA, polyacrylate, polycarbonate, and the like. Such aspects can exhibit an ambient temperature ionic conductivity ranging from 1E-7 S/cm to 1E-4 S/cm. In some other aspects, the activated SPE can comprise PEO in combination with lithium salts selected from LiFSI, LiBETI, LiTf, LiClO₄ LiBOB. In such aspects, the activated SPE can exhibit an ambient temperature ionic conductivity ranging from 1E-8 S/cm to 1E-4 S/cm. In yet other aspects, the activated SPE can comprise LiTFSI in combination with PEO and a plasticizer or ionic liquid, such as polythiazyl, ethyl cellulose, polyacrylic acid, poly(methyl methacrylate), or (PYR₁₄) TFSI. In such aspects, the activated SPE can exhibit an ambient temperature ionic conductivity ranging from 1E-5 S/cm to 1E-3 S/cm. In some representative aspects, the activated SPE exhibits an ambient temperature ionic conductivity of 0.01 mS/cm as compared to an untreated SPE, which only exhibits an ambient temperature ionic conductivity of 0.002 mS/cm.

The activated SPE can be used in combination with any type of solid-state battery that uses lithium ions, including all-solid-state batteries having various types of cathode materials (e.g., LiNiₓMn_{y}Co₂O₂ (NMC), LiCoO₂ (LCO), LFP, etc.) and anode materials (e.g., Li, Li₄Ti₅O₁₂ (LTO), graphite, Si, Na, etc.). In particular aspects, the activated SPE is used with an all-solid-state lithium iron phosphate/lithium battery (or cell thereof when the battery comprises two or more cells). Solid-state batteries comprising the activated SPE exhibit improved ambient temperature performance (or performance below ambient temperature) as compared to solid-state batteries without an SPE that has been activated according to the disclosed method. In some aspects, the solid-state battery comprising the activated SPE exhibits an ambient temperature specific capacity that is 50 mAh/g or higher, such as 75 mAh/g, or 100 mAh/g, or 125 mAh/g, or 150 mAh/g, or 200 mAh/g, or 2000 mAh/g. In contrast, a similar solid-state battery that does not comprise the activated SPE exhibits an ambient temperature specific capacity that is less than 20 mAh/g.

### V. Overview of Several Embodiments

Disclosed herein is a method for activating a solid polymer electrolyte (SPE) for use in a solid-state polymer battery, the method comprising exposing the SPE to activating conditions selected from i) heat and pressure, or (ii) sonication to produce an activated SPE, wherein the activated SPE exhibits a higher ambient temperature ionic conductivity than the SPE prior to activation.

In any or all of the above embodiments, the activated SPE exhibits fewer crystalline phases and/or fewer grain boundaries than the SPE prior to activation.

In any or all of the above embodiments, crystalline phases and/or grain boundaries of the activated SPE are evaluated using backscattered electron imaging, differential scanning calorimetry, or a combination thereof.

In any or all of the above embodiments, the activated SPE exhibits increased interfacial contact with an electrode active material of the solid-state polymer battery relative to the SPE prior to activation.

In any or all of the above embodiments, interfacial contact is evaluated by measuring resistance between the electrode active material and the SPE.

In any or all of the above embodiments, exposing the SPE to activating conditions comprises heating the SPE at a temperature ranging from a temperature greater than 40° C. to a temperature of 100° C. and applying a pressure ranging from 0.1 MPa to 10 MPa.

In any or all of the above embodiments, pressure is applied for a time period ranging from greater than or equal to 15 minutes.

In any or all of the above embodiments, the SPE is present in combination with an electrode active material, an anode, a cathode, a membrane, a separator, or any combination thereof.

In any or all of the above embodiments, the SPE is activated after introducing the SPE into a cell to first form the SPE-containing solid-state battery, and wherein the activating conditions are applied to the SPE-containing solid-state battery.

In any or all of the above embodiments, the SPE-containing solid-state battery comprising the activated SPE exhibits a specific capacity that is greater than or equal to 100 mAh/g after 100 charge-discharge cycles when operated at ambient temperature or lower.

In any or all of the above embodiments, heating comprises using elevated temperature or microwaves.

In any or all of the above embodiments, the SPE further comprises an additive, wherein the additive comprises a metal oxide, a metal sulfide, a metal halide, or a combination thereof.

In any or all of the above embodiments, the SPE comprises the additive in an amount ranging from 1 wt. % to 80 wt. %.

In any or all of the above embodiments, the SPE is provided as a coating layer on an electrode active material.

Also disclosed herein are embodiments of an all-solid-state polymer battery, comprising: a cathode; an anode; and an activated solid polymer electrolyte (SPE), wherein the activated SPE has been activated according to any or all of the above embodiments.

In any or all of the above embodiments, (i) the activated SPE exhibits fewer crystalline phases and/or fewer grain boundaries than an SPE that has not been activated according to the method according to any or all of the above embodiments; and/or (ii) the activated SPE exhibits increased interfacial contact with an electrode active material of the polymer electrolyte solid-state battery relative to an SPE that has not been activated according to the method according to any or all of the above embodiments.

In any or all of the above embodiments, the SPE-containing solid-state battery has an ambient temperature specific capacity of greater than or equal to 100 mAh/g after 100 charge-discharge cycles.

In any or all of the above embodiments, the SPE comprises a mixture of a polymer and an alkali salt, wherein the polymer is selected from polyethylene oxide, polyacrylonitrile, polymethyl methacrylate, polyvinylidene fluoride, polycarbonate; and the alkali salt is selected from lithium bis(trifluoromethane)sulfonimide, lithium perchlorate (LiClO₄), lithium hexafluorophosphate (LiPF₆), lithium bis(fluorosulfonyl)imide (LiCF₃SO₃) (LiFSI), lithium bis(pentafluoroethanesulfonyl)imide (Li(C₂F₅SO₂)₂N) (LiBETI), lithium trifluoromethanesulfonate (LiCF₃SO₃) (LiTf), lithium bis(oxalato)borate (LiB(C₂O₄)₂) (LiBOB), lithium difluoro (oxalato) borate (LiBF₂(C₂O₄)) (LiODFB), lithium nitrate (LiNO₃), lithium iodide (LiI), sodium perchlorate (NaClO₄), sodium bis(trifluoromethanesulfonyl)imide (NaTFSI), magnesium bis(trifluoromethanesulfonimide) (Mg(TFSI)₂), or a combination thereof.

Also disclosed is a method for activating a solid polymer electrolyte (SPE) for use in a solid-state polymer battery, the method comprising: exposing the SPE to a temperature ranging from a temperature higher than 40° C. to a temperature of 100° C. and a pressure ranging from 0.5 MPa to 10 MPa, to produce an activated SPE; and allowing the SPE to cool to ambient temperature prior to operating any solid-state polymer to which the SPE is added, wherein the activated SPE exhibits a higher ambient temperature ionic conductivity than the SPE prior to activation.

Also disclosed is an activated solid polymer electrolyte (SPE) comprising an alkali salt and a polymer component, wherein the activated SPE is free of crystalline regions and that exhibits an ambient temperature ionic conductivity that is three to ten times higher than an ambient temperature ionic conductivity exhibited by an untreated SPE having the alkali salt and polymer component as the activated SPE.

### VI. EXAMPLES

### Materials

Poly(ethylene oxide (“PEO”) (Sigma-Aldrich, Mw. 600000) and carbon-coated LFP (MSE, 1.5 μm D50) powders were dried at 80° C. and under vacuum for 24 hours prior to use. Other chemicals were used as received. Preparation of SPE electrolyte, LFP cathodes, and coin cells were performed in a glovebox (M. Braun) filled with argon with both O and moisture levels below 1 ppm except the cathode slurry mixing step that was performed in an ambient condition.

Characterization. The activated electrolytes were sealed in air-proof containers filled with argon to avoid air contamination before being transferred to characterization instrument. Observation of sample morphology was performed using a JEOL JSM-IT200 SEM system. XRD measurements were performed using a Rigaku Miniflex II diffractometer with Cu Kα radiation (λ=1.541 Å) at a scanning speed of 2° min⁻¹ (2θ). Samples were sealed in Kapton tape pouches in advance to avoid air contamination before XRD testing. TG and DSC analysis was performed on a NETZSCH STA 449F3 Jupiter-thermal analysis systemin argon atmosphere. TG was performed at the heating rate of 5° C. min⁻¹ from 20 to 700° C. DSC was performed at the heating rate of 5° C. min⁻¹ from 22 until 200° C.

### Example 1—Preparation of SPE Electrolyte

LiTFSI (Solvionic) as the Li salt and PEO as the polymer were dissolved in acetonitrile (Sigma-Aldrich) to form a uniform solution under stirring at an O:Li ratio of 18. The solution was casted on a copper (Cu) foil (China Energy Lithium Co., Ltd) and dried at 80° C. and under vacuum conditions for 24 hours. The obtained free-standing dry SPE film with a thickness of 120 μm and a density of 1.4 g cm⁻³ was then punched into disks with a diameter of 19 mm for an electrolyte separator for coin cells.

### Example 2—Preparation of Lithium Iron Phosphate (“LFP”) Cathode

Carbon-coated LFP was mixed with the aforementioned PEO-LiTFSI acetonitrile solution as a binder, super P (MTI) as a carbon conductor in acetonitrile to form a uniform slurry. The weight ratio of LFP, PEO-LiTFSI, carbon was 7:2:1. The slurry was casted on a carbon-coated Al foil with a thickness of 18 μm (Guangzhou Nano New Material Technology Co., Ltd) and dried at 80° C., vacuum conditions for 12 hours resulting LFP cathode at a LFP loading of 2 mg cm⁻², an electrode density of 1.2 g cm⁻³.

### Example 3—Assembly of Coin Cell

The diameters of LFP cathode and Li anode (thickness 250 μm, TMAX) were 12.7 mm and 16 mm, respectively. The spacer, made of stainless steel (thickness 0.5 mm, MTI), has a diameter of 15.5 mm. Four types of 2032-type coin cells were assembled: the spacer|SPE|spacer symmetric cells, the LFP|SPE|LFP symmetric cells, the Li|SPE|Li symmetric cells, and the LFP|SPE|Li full cells. The N/P ratio for the LFP|SPE|Li full cell was 147.

### Example 4—Cell Activation and Electrochemical Tests

In the activation process of different temperatures, the cell components were crimped into coin cell cases without applying additional pressure. The assembled coin cells were rested at 30° C. for 24 hours and denoted as “pristine” state. Two methods were used to activate the pristine batteries at different temperatures ranging from 40° C.-100° C. One method, referred to herein as “CHT,” involved galvanostatically charging/discharging the batteries at 0.1 C (1 C=170 mAh g⁻¹) for 2 cycles. The other method, referred to as “RHT,” involved resting the batteries for 48 hours at desired temperatures. This duration was used because it was comparable to the time required for the CHT activation process. The activated batteries were denoted as CHTx and RHTx, respectively, where x is the heating temperature. The activation process of electrolytes under different pressures was conducted in the glovebox environment. The spacer|SPE|spacer assembly was mounted into a compressing jig (MTI) at pressures of 0.25-10 MPa. The setup was rested at 80° C. for 24 hours and cooled to ambient temperature for an additional 24 hours before disassembly. The activated electrolytes were denoted as PyRHTx, with y representing the applied pressure in MPa on the electrolyte. In the activation process of different pressures for batteries, the laminated LFP|SPE|Li coin cell cores were sealed in Al pouches and mounted to the compressing jig at a pressure of 0-10 MPa, rested at 30° C. or 80° C. for 3 hours, then carefully transferred back to glovebox to avoid cell component interface displacement and crimped into coin cell cases. The activated coin cells were rested at 30° C. for 24 hours to achieve temperature uniformity and stability prior to electrochemical tests. The EIS tests were measured and fitted by an EC-Lab Bio-logic workstation in the range of 1 MHZ-0.1 Hz with an amplitude voltage of 5 mV at 30° C. The obtained resistance results were normalized by the geometric surface area. The normalized resistance of cathode and anode symmetric cells is divided by two because two interfaces were tested. The SPE electrolyte conductivity was estimated by σ=l/RA, where σ is the conductivity, l is the distance between the block electrodes, here is the thickness of SPE electrolyte, R is the measured impedance, A is the geometric area of the block electrode, here is the area of the spacer. The electrochemical performance test of full cells was galvanostatically charge and discharge in a voltage range of 2.75 V-3.8 V (vs. Li⁺/Li) at 30° C., 0.02 C. After activation and electrochemical tests, the cells were disassembled in the glove box and the electrolytes were harvested for further post-activation characterization.

### Example 5—CHT and RHT Evaluations

As discussed above, a cell testing protocol was designed (see FIG. 6) to activate the cells at 40-100° C. Two activation methods were employed and compared: (1) cycling at high temperature (CHT) for two cycles, and (2) resting at high temperature (RHT) for 48 hours. Both methods were followed by a 24-hour rest period to ensure the cells cooled to ambient temperature before subsequent testing. The activated cells were denoted as CHTx and RHTx where x indicates the heat treatment temperature. The cell configuration included LFP as the cathode, poly(ethylene oxide)-lithium bis(trifluoromethane)sulfonimide (PEO-LiTFSI) as the SPE, and Li metal as the anode, assembled into coin cells with a regular internal pressure, without any external pressure applied.

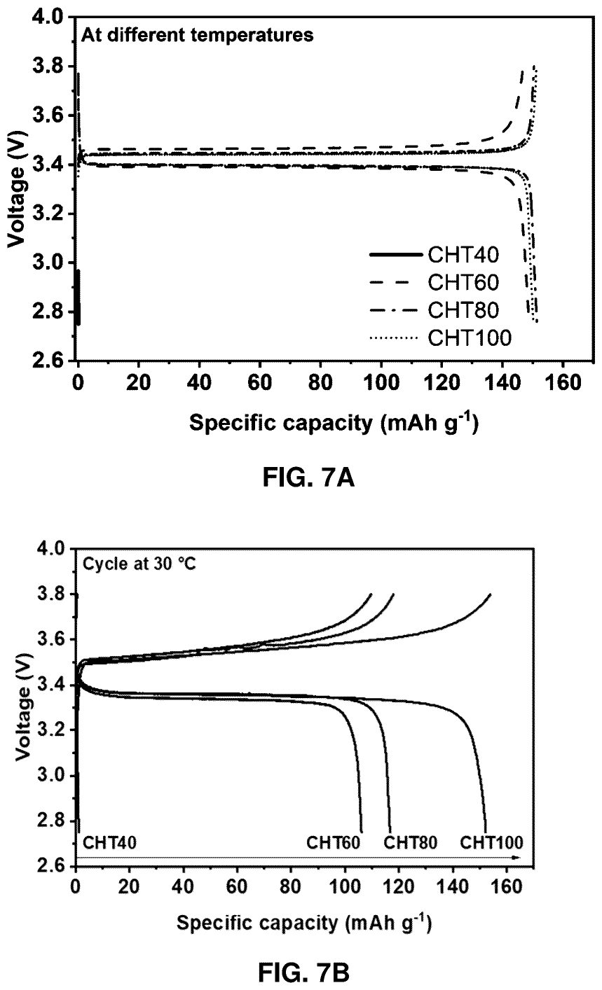

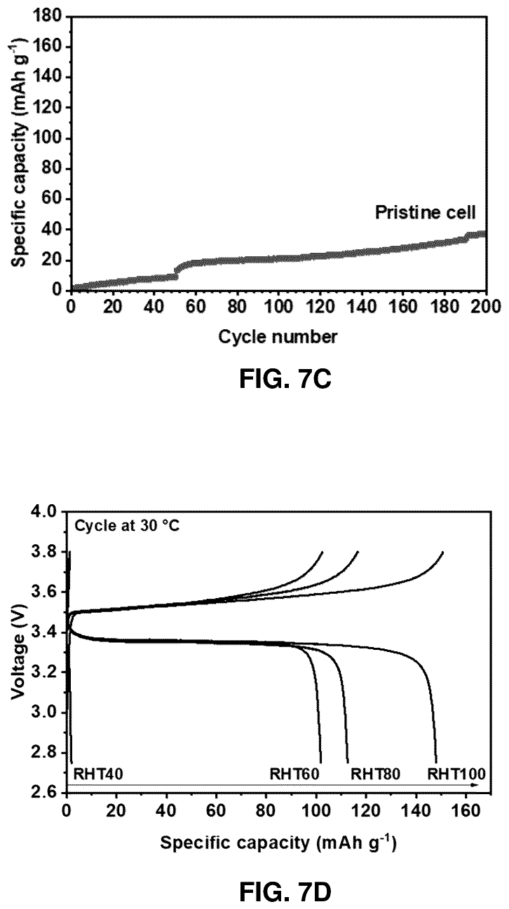

In the CHT activation process, all batteries exhibited high reversible specific capacities (>148 mAh g⁻¹) and small overpotentials (<0.1 V) at temperatures ≥60° C., as depicted in FIG. 7A, indicating good kinetics of the components and relatively low resistance of the full cell. FIG. 7B compares the ambient temperature charge/discharge profiles of CHT-activated batteries at various temperatures. Without activation, the pristine battery shows a very low specific capacity (1.4 mAh g⁻¹) in the first cycle at ambient temperature (FIG. 7C). Although it gradually increased in the following cycles, it remains below 40 mAh g⁻¹ even after 200 cycles, indicating that it is difficult to operate at ambient temperature. After activation, the CHT40 cell showed negligible capacity increase compared to the pristine one, indicating that activation at 40° C. has little effect. Notably, increasing the CHT temperature to 60° C. resulted in a substantial improvement in capacity (106 mAh g⁻¹), suggesting that 60° C. may be minimum temperature for certain examples to enable ambient temperature-operation of SPE-based cells. Further improvements were achieved by raising the CHT activation temperature. For instance, through CHT activation at 100° C., the cell delivered a high specific capacity of 152 mAh g⁻¹, comparable to the performance of cells operated at constant high temperatures (FIG. 7A). It is noted that CHT involved both heating and electrochemical cycling, potentially benefiting cell activation.

To decouple the impacts of those two processes, RHT activation was performed, where cells were only rested at the elevated temperatures for a specified duration. A similar trend of temperature-dependent capacity activation was observed for certain examples: minimal effect from resting at 40° C., while resting at ≥60° C. significantly enhanced cell capacity (FIG. 7D). The comparison of CHT and RHT suggests instead of electrochemical cycling, the heating step can play a dominant role in cell activation.

### Example 6—Morphology, Structure, and Ion Transport Evaluations for Activated SPE

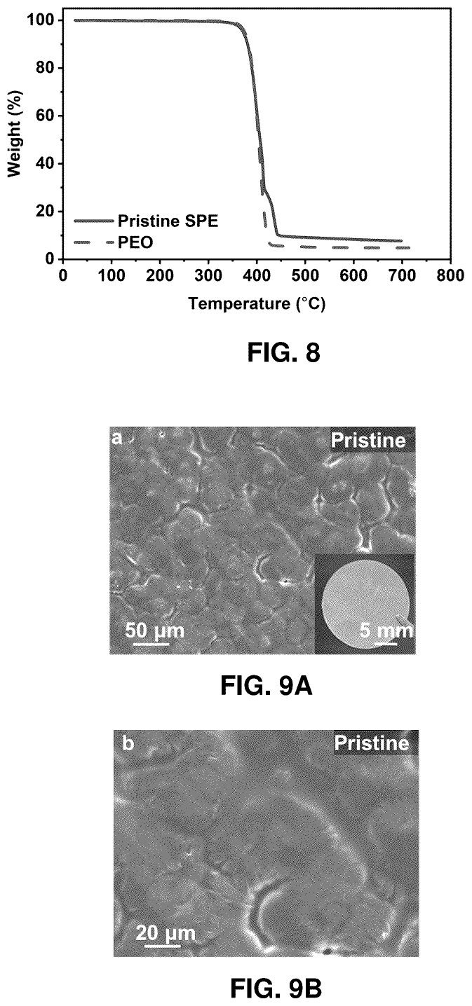

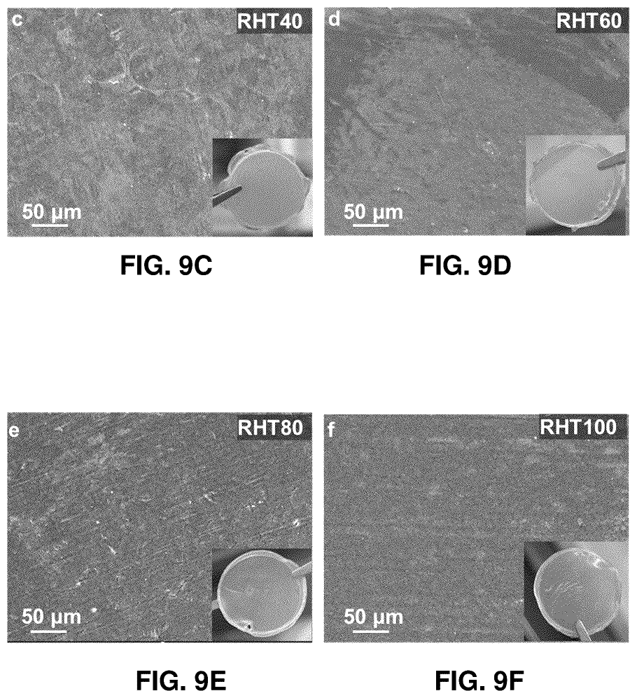

The impact of RHT activation on SPE morphology, structures, and Li⁺ transport was evaluated utilizing symmetric cells with SPE sandwiched by two stainless-steel spacers as blocking electrodes. The cells underwent pre-heating through RHT activation at various temperatures and were subsequently cooled to ambient temperature. After the activation, the cells were disassembled and the SPEs were examined. In this example, the SPE's activation was performed within a coin cell, and the SPEs were activated under the internal pressure of the coin cell. First, thermogravimetric analysis was conducted on the PEO and pristine SPE (FIG. 8). Both curves show no weight loss below 100° C., suggesting that there was no chemical composition change during the RHT activation. The impact of RHT activation on SPE morphology was substantial (FIGS. 4A-4E). The pristine SPE film exhibited assembled spherulites with distinct grain boundaries, as observed in backscattered electron (BSE) images (FIG. 4A) and scanning electron microscopy (SEM) images (FIGS. 9A and 9B). These spherulites are widely observed in polymers and SPEs that crystallize from melts or concentrated solutions. The boundaries between these spherulites is examined and the term “grain boundaries” is used when referring to them. Upon pre-heating treatment at 40° C., the RHT40 SPE displayed reduced boundaries and voids (FIG. 9C), although rich boundaries were still observed in BSE images (FIG. 4B). With further elevation of the activation temperature to 60° C. and above, the grain size started to decrease and grain boundaries began to merge, resulting in integrated grains with disappeared boundaries (FIGS. 4C-4E and FIGS. 9D-9F). This suggests amorphization of the SPE grains and inter-grain growth upon RHT activation.

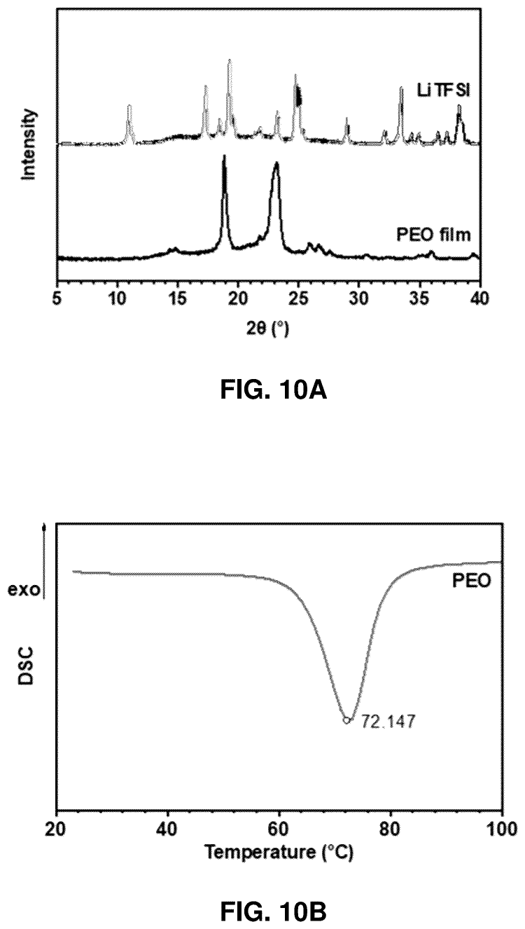

To investigate whether structural/morphological changes were maintained once the temperature returns to ambient temperature (or if constant heating was instead required to maintain these changes), RHT-activated SPEs were studied via X-ray Diffraction (XRD) at ambient temperature (FIG. 1). In comparison to the XRD patterns of pure PEO (FIG. 10A), the pristine SPE, subjected to drying at 80° C. under vacuum, shows distinct diffraction peaks at 11° and 14°. Furthermore, in comparison to the XRD pattern of LiTFSI (FIG. 10A), aside from the peak at 11°, most of the characteristic peaks of LiTFSI, such as those at 17.4°, 19.3°, 24.8°, and 33.5°, have disappeared, indicating that LiTFSI was completely dissolved or reacted. Therefore, the peaks at 11° and 14° in the pristine SPE are characteristic and attributed to the formation of the PEO-LiTFSI complex. However, following RHT activation at 40° C., a significant decrease in crystallinity was observed, as evidenced by the weakened 11° and 14° peaks and a transition from an opaque to transparent state. The XRD and BSE results indicate that the RHT-induced amorphization occurs earlier within SPE grains than the merging between grains. When the activation temperature is raised to 60° C. or above, the 11° and 14° peaks are almost disappeared, suggesting the complete amorphization of the PEO-LiTFSI complex.

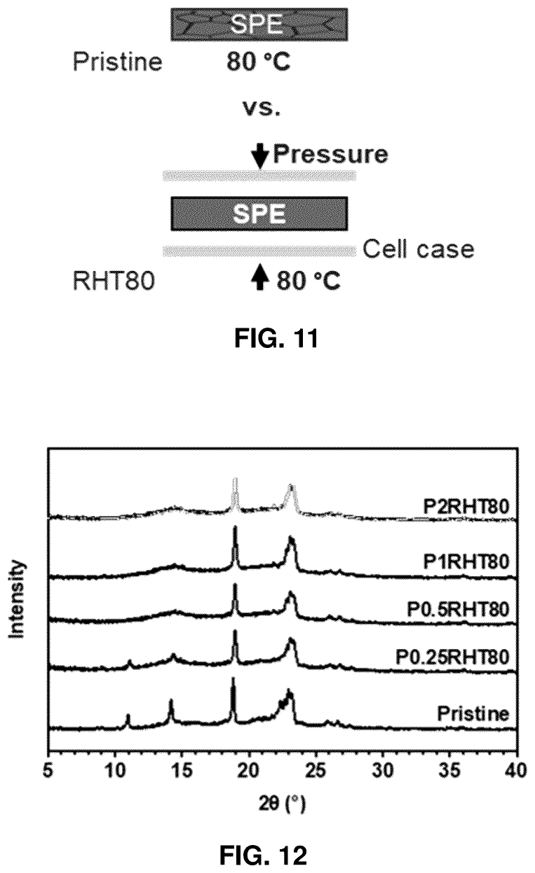

Differential scanning calorimetry (DSC) analyses were conducted on the RHT-activated SPEs to confirm changes in crystallinity (FIG. 2). The pristine electrolyte displays two broad endothermic peaks at 39.2° C. and 58.2° C. in the DSC curves. The peak at 39.2° C. corresponds to the transition of crystalline PEO-LiTFSI complex into an amorphous state, while the peak at 58.2° C. indicates the melting of the PEO (FIG. 10B). The broad nature of these peaks suggests low crystallinity of PEO-LiTFSI and PEO in the pristine electrolyte. The persistence of the 39.2° C. peak in RHT40 indicates the presence of PEO-LiTFSI complex crystals after activation at 40° C.; however, this peak disappears in the RHT60 sample, suggesting that the PEO-LiTFSI complex completes amorphization at RHT ≥60° C. Higher RHT activation temperatures consistently resulted in the absence of this peak, confirming complete amorphization of SPEs. Additionally, the 58.2° C. peak shifted to lower temperatures with increasing activation temperature, indicating concurrent amorphization of the PEO. The observations of DSC study align well with the XRD results and confirm that, for certain examples, RHT at temperatures ≥60° C. leads to significant amorphization PEO-LiTFSI and PEO crystals. As indicated herein, there is a clear difference between the RHT and direct heating that is used for conventional operation of solid-state batteries. Comparing preparation conditions of RHT80 and pristine SPE films, both undergo heat treatment at 80° C., a key difference lies in the RHT80 activation is conducted within a coin cell under a specific pressure (FIG. 11) while no pressure for the pristine SPE fabrication. Here, this RHT activation is attributed to a pressure-induced amorphization (PIA) process. Without being limited to a single theory, it currently is believed that as the temperature approaches the polymer melting point (Tₘ), the SPE starts to amorphize. Upon cooling, due to the presence of pressure, the amorphized SPE preserves its disordered orientation.

To determine the pressure threshold for the process, the SPE was sandwiched between two stainless steel spacers and compressed using a jig under various pressures. The setup was held at 80° C. for 24 hours and then cool to ambient temperature and rested for 24 hours before conducting XRD (FIG. 12). Comparison with the pristine electrolyte revealed that at low pressures, such as 0.25 MPa (P0.25RHT80), small peaks at 11° and 14° persisted, indicating PEO-LiTFSI complex recrystallization from the amorphous state. However, increasing the pressure to 0.5 MPa and above significantly weakened these peaks, indicating amorphization of the PEO-LiTFSI complex. These results strongly suggest that, for certain examples, at temperatures ≥60° C. and pressures ≥0.5 MPa, the PEO-LiTFSI electrolyte undergoes a PIA. This pressure threshold is much lower than that reported for other polymer systems. However, applying excessively high pressure can damage the SPE film. For instance, after RHT80 activation at 10 MPa, the SPE was heavily deformed and could no longer be used as a solid-state electrolyte.

### Example 7—Electrochemical Evaluations

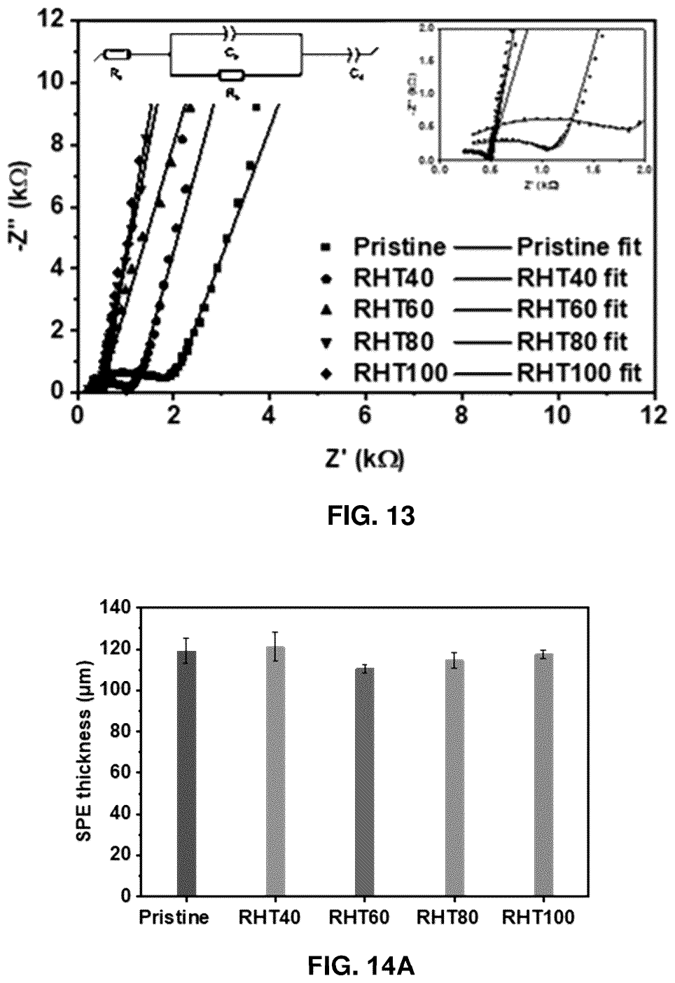

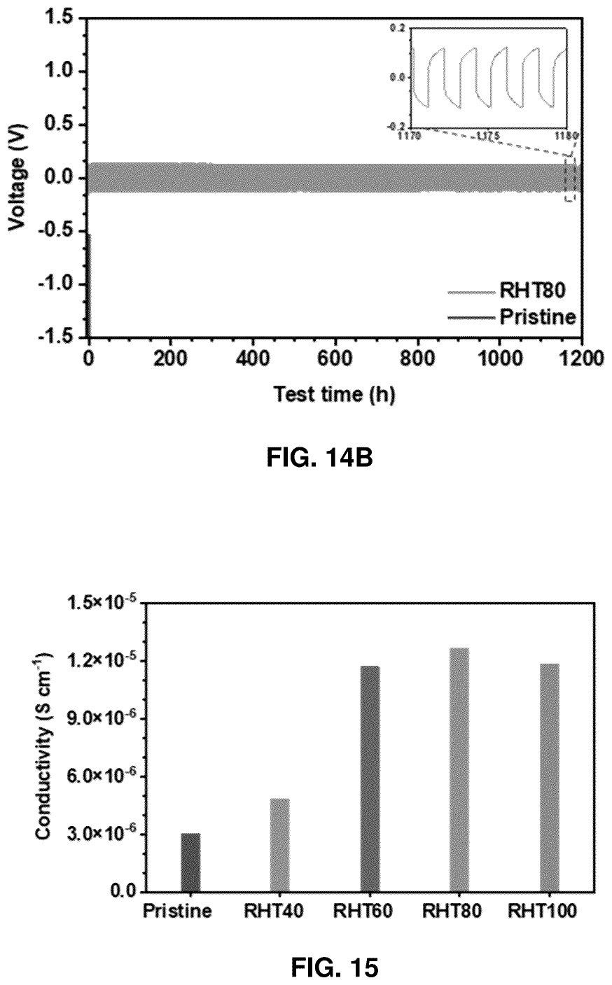

The effect of RHT activation on the electrochemical properties of the SPEs was evaluated in this example. Electrochemical impedance spectroscopy (EIS) analyses were performed on the pristine and activated electrolytes (FIG. 13). The EIS spectra of the batteries displayed depressed semicircles, which may be due to uneven electrode-electrolyte interface and irregular thickness and morphology of the SPEs. Without RHT activation, the pristine SPE exhibits an overall resistance of approximately 1.8 kΩ. This substantial resistance aligns with previously reported findings and can be attributed to the high boundary and high intra-grain resistances. Following a RHT treatment at 40° C., the ambient temperature resistance was notably decreased to 1 kΩ, marking a 50% reduction. Further increasing the RHT treatment temperature to 60° C. resulted in another 50% drop, bringing the overall resistance to 0.5 kΩ. For temperatures above 60° C., the cell resistance stabilized eventually. To verify if the EIS reduction was caused by the thickness variation in the SPEs at elevated temperatures, the SPE thicknesses were measured post activation (FIG. 14A) and utilized these actual values for ionic conductivity calculations. Relative to the pristine SPE, the activated SPEs exhibited a fourfold improvement in ionic conductivity (FIG. 15; values shown in Table 1). The ambient temperature conductivity enhancement was attributed to the reduced grain boundaries and polymer amorphization, which is consistent to the XRD and DSC results. Further increase of temperatures exceeding 60° C. did not yield many improvements in ionic conductivity, indicating full activation and stabilization during RHT activation around 60° C. Additionally, the ambient temperature cycling performance of Li|Li symmetric cells using RHT80 electrolyte was evaluated (FIG. 14B). In contrast to the pristine electrolyte that failed to cycle at ambient temperature, the RHT80 exhibited stable cycling (>1180 h) at 0.02 mA cm⁻².

TABLE 1
Ambient Temperature Ionic Conductivity Values

| Sample | Conductivity (S/cm) |
|---|---|
| Pristine | 3.02E−06 |
| RHT40 | 4.82E−06 |
| RHT60 | 1.17E−05 |
| RHT80 | 1.27E−05 |
| RHT100 | 1.18E−05 |

### Example 8—Comparison Between LFP and Li

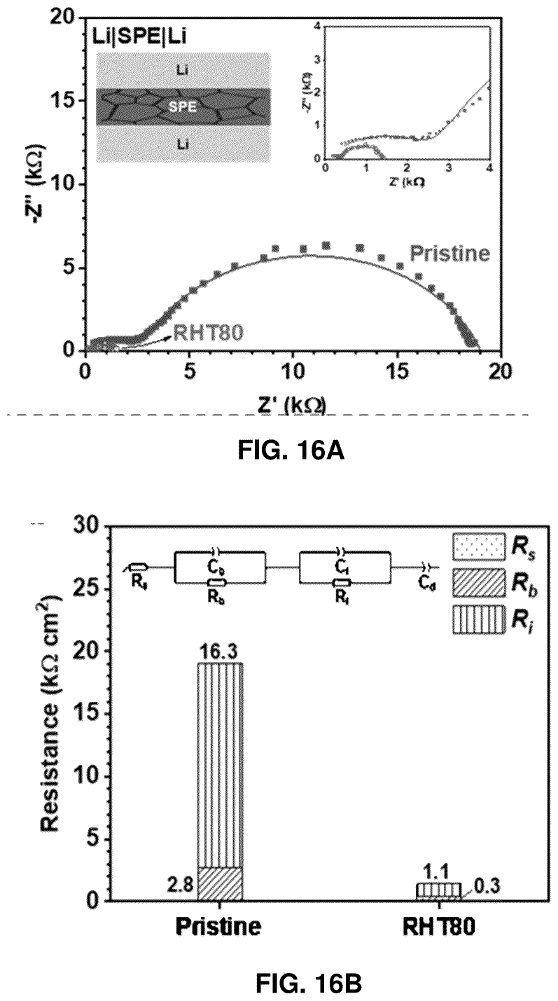

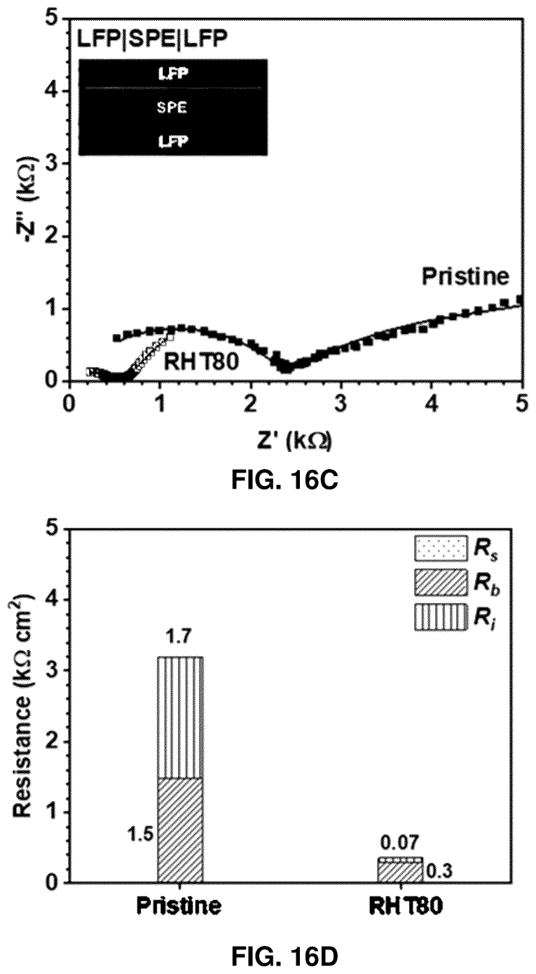

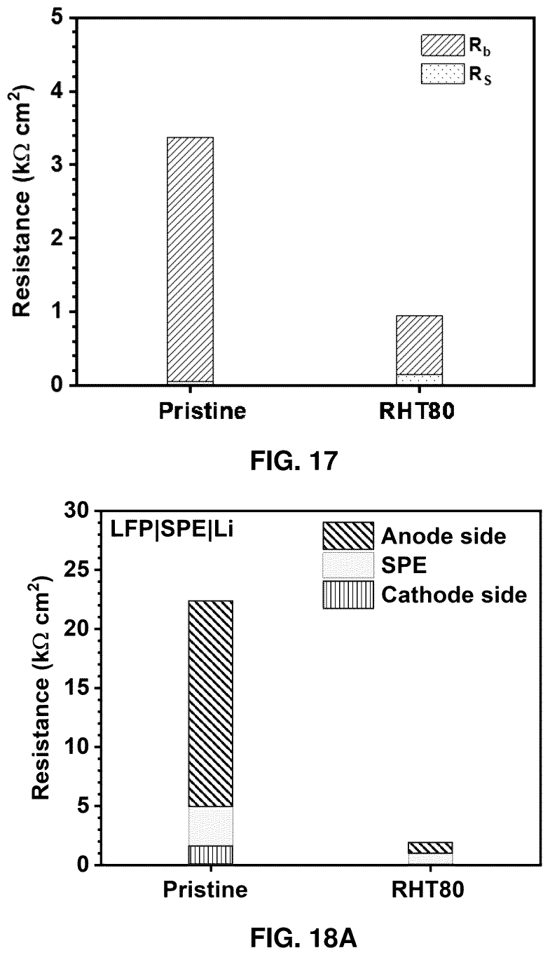

In addition to examining the SPE, the impact of RHT activation on the Li|SPE and LFP|SPE interfaces was investigated using Li|SPE|Li and LFP|SPE|LFP symmetric cells. The ambient temperature EIS spectrum of the RHT80 battery was analyzed and presented as an illustrative example to showcase the activation effects (FIGS. 16A-16D). The pristine Li|SPE|Li cell at ambient temperature exhibits a significantly higher overall resistance than that of the spacer|SPE|spacer cell (18 kΩ in FIG. 16A vs. 1.8 kΩ in FIG. 13), indicating substantial interfacial resistance between Li and SPE. An equivalent circuit, shown in FIG. 16B, was employed to fit the EIS spectra. The simulated interfacial resistance (Rᵢ) is more than 5.9 times the bulk resistance (R_{b}), indicating that the Li|SPE interface posed a more formidable obstacle to Li⁺ transport compared to the SPE alone (FIG. 17). Following RHT activation, using RHT80 as an example, the total cell resistance decreases to less than one-tenth of the pristine cell. This reduction is primarily contributed to the decrease in Li|SPE interfacial resistance, accounting for over 93% of the change in cell resistance. Insufficient contact between the electrode and SSEs often results in elevated cell resistance. In contrast to conventional batteries where the liquid electrolyte can flow and wet the electrode easily, the interfacial resistance of ASSLB heavily relies on the physical solid-solid contact between the SSE and Li. Under RHT activation, the SPE, due to its plastic/elastic properties, establishing a conformal contact with the Li anode and reducing the Li|SPE interfacial contact resistance. Beyond contact and morphological changes, the Li|SPE interfacial resistance is also associated with the chemical interactions between the SPE and Li. RHT activation may facilitate the formation of a less resistive interface, as supported by the increased Q; (Table 2), the pre-factor of the constant phase element (C) in the equivalent circuit, indicating a reduction of the interfacial layer thickness. Similar activation effects were observed on the LFP|SPE interface. As demonstrated in FIGS. 16C and 16D, the LFP|SPE interfacial resistance decreased from 1.7 kΩ to 0.07 kΩ after RHT activation at 80° C. It is evident that RHT activation significantly reduces the resistance of SPE, Li|SPE, and LFP|SPE interfaces. Among these, the Li|SPE interface emerges as the primary determinant of the overall cell resistance, a topic further discussed in the subsequent sections.

TABLE 2
Parameters of constant phase elements in equivalent circuits fitted
for Li|SPE|Li symmetric batteries.

| | α_{b} | Q_{b} [Fs^{(α-1)}] | αᵢ | Qᵢ[Fs^{(α-1)})] |
|---|---|---|---|---|
| Pristine | 0.57 | 1.9 × 10⁻⁷ | 0.78 | 9.9 × 10⁻⁷ |
| RHT80 | 0.76 | 3.7 × 10⁻⁸ | 0.81 | 5.5 × 10⁻⁶ |

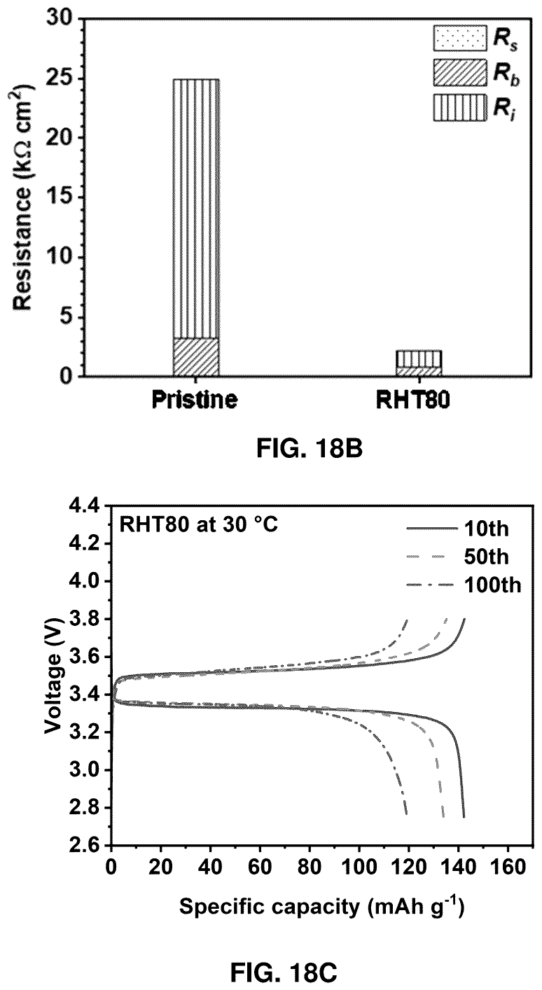

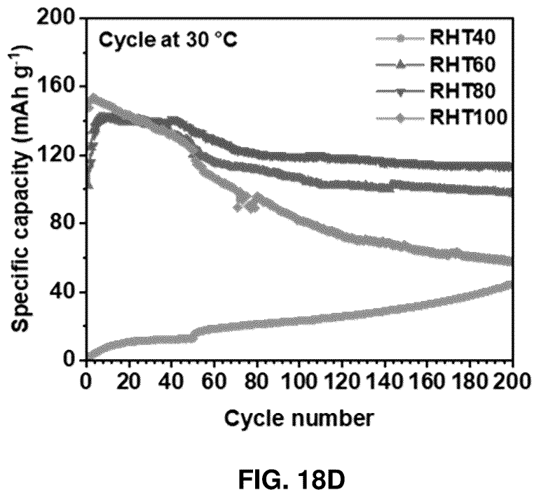

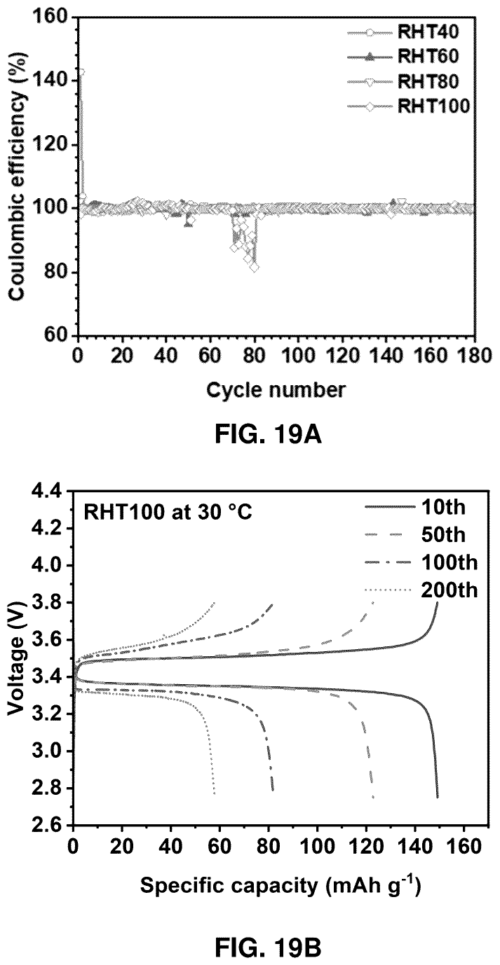

By analyzing the decoupled interfaces of spacer|SPE, Li|SPE, LFP|SPE using individual symmetric cells, the interfacial resistance and its distribution in the LFP|SPE|Li full cell can be estimated. Illustrated in FIG. 18A, the Li|SPE interfacial resistance in a pristine LFP|SPE|Li full cell constitutes more than 70% of the total cell resistance. Following RHT activation, this resistance can be significantly reduced by up to 90%. While the SPE resistance is smaller than that of Li|SPE interface, it remains larger than that of LFP|SPE interface. This reduction in resistance is attributed to lower SPE boundary resistance and improved interfacial contact. To validate the estimation, LFP|SPE|Li full cells were constructed. The EIS spectra were measured and then fitted using the equivalent circuit diagram inserted in FIG. 16B. The assembled full cell exhibits resistance and an evolution trend upon RHT activation very similar to the estimated values (FIG. 18B). This confirms that the analysis of individual symmetric cells provides a robust foundation for understanding and deciphering the complexities of full cells. To verify whether the RHT activation could enhance cell performance at ambient temperature, LFP|SPE|Li cells, post-RHT80 activation, were cycled at ambient temperature, 0.02 C. The cell delivers an initial specific capacity exceeding 110 mAh g⁻¹, reaching 142 mAh g⁻¹ in the 10th cycle with a small overpotential of 0.2 V (FIG. 18C). Even after the 100th cycle, the cell's specific capacity remains above 110 mAh g⁻¹ and high Coulombic efficiency (FIG. 19A). During the cycling, while the specific capacity may vary, the charge and discharge plateaus and overpotential remain consistent, indicating the stable ambient temperature cycling of RHT-activated battery. To optimize the activation temperature, RHT activation was conducted on full cells at different temperatures (FIG. 18D). As mentioned earlier, RHT40 has minimal effect on cell activation for certain examples. RHT activation at temperatures above 60° C. effectively improves the cell's specific capacity, with higher temperatures exhibiting a more profound effect.

However, it should be noted that cells activated at temperatures above 100° C. experience quicker capacity decay during long-term cycling. To investigate the causes of capacity deterioration, the charge and discharge profiles of RHT100 were compared at different cycles (FIG. 19B). It showed a continuous increase in overpotential accompanied by a decrease in specific capacity during cycling particularly after 100 cycles, which suggests an increase of cell resistance upon cycling. This was assigned to the side reactions between the Li anode and the SPE. Additionally, it has been reported that the degradation of the SPE could cause capacity loss, which may result from the mechanical instability and, in particular, high-temperature (≥100° C.) thermal instability of the PEO-LiTFSI membrane. Furthermore, the LFP cathode may deform and creep under the high-temperature (≥100° C.) activation, like the SPE, leading to cathode deformation and capacity loss during the extended cycling. Balancing specific capacity and cell cycling, 80° C. is determined to be the optimal RHT activation temperature. It is noteworthy that the cell cycling rate remains low compared to the reported cells operated at high temperatures. This is mainly due to high crystallinity of the EO chains. However, the activated cells demonstrated a significant improvement in capacity and cycle stability compared to the pristine cells (FIG. 7C). The activation process is designed to serve as a universal pretreatment method to reduce boundary and interfacial resistances of polymer-based ASSLBs using the basic PEO-LiTFSI electrolyte as a model system. In-situ polymerization is another promising approach to improve ionic conductivity. However, due to potential residue of monomers or oligomers, the long-term stability of in-situ polymerized electrolytes remains uncertain.

### Example 9—Pressure Evaluations

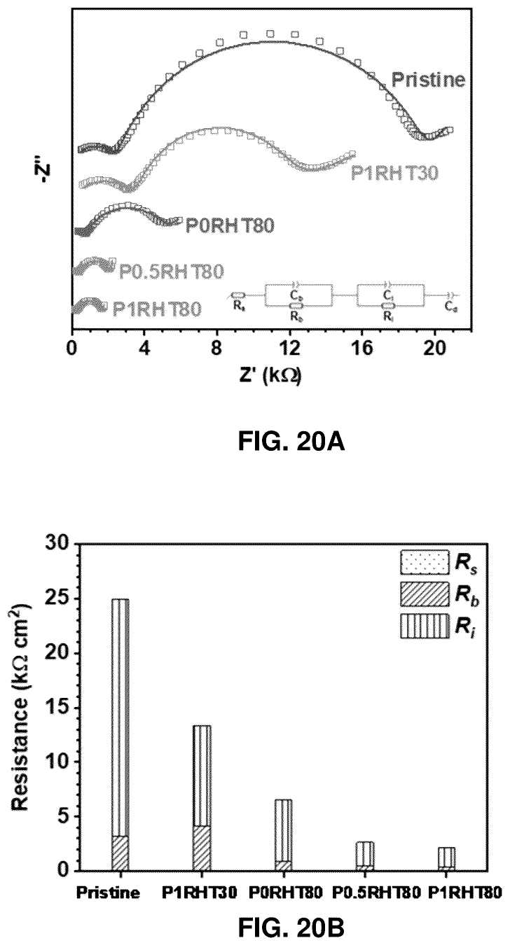

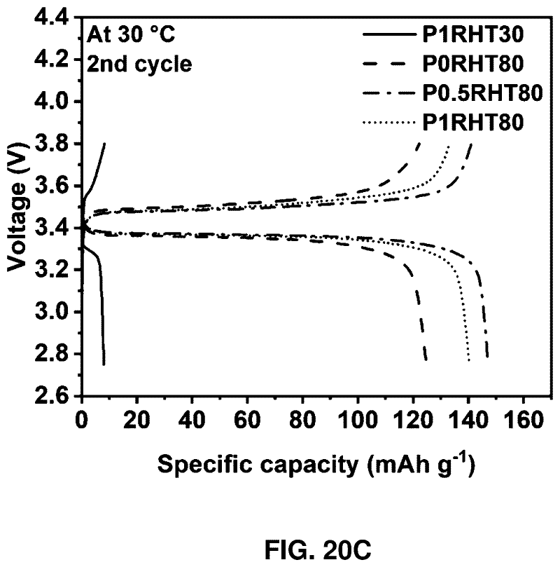

To clarify the impact of pressure on the full cell during RHT activation, LFP|SPE|Li full cells were subjected to different pressing and heating conditions for 3 hours before being sealed in coin cell cases. The cells' EIS were then measured at ambient temperature, fitted using the equivalent circuit diagram inserted, and then compared to the pristine cell (FIGS. 20A and 20B). When only high pressure (1 MPa) was applied, the cell resistance reduced by only 31% (P1RHT30). The EIS fitting result indicates that the R_{b} was almost maintained, while the reduced cell resistance is mainly contributed by a reduction in Rᵢ. This suggests that pressure is beneficial for improving interfacial contact but has a limited effect on the SPE bulk resistance. In contrast, when only heating is applied, the cell resistance can be reduced by 72% (P0RHT80). The EIS fitting indicates that both Rᵢ and R_{b} were reduced, suggesting that temperature has a more substantial effect than pressure. Simultaneously applying mild pressure (0.5 MPa) and heating (P0.5RHT80) significantly reduces cell resistance by 90%. At the given temperature, increasing pressure has a negligible effect on cell resistance (P1RHT80) and extremely high pressure causes severe SPE deformation and cell short (P10RHT80). This study suggests that, for certain examples, 0.5 MPa to 1 MPa is suitable for cell activation, a finding confirmed by ambient temperature cell cycling performances (FIG. 20C). Post-pressing along, the cell's specific capacity remains limited. Post-heating along increases the specific capacity to 124 mAh g⁻¹. However, after simultaneous pressing and heating at 0.5 MPa and 80° C., the cell exhibits the highest specific capacity, 147 mAh g⁻¹. Further increasing the pressure does not lead to higher specific capacity, possibly due to high pressure causing severe deformation and degradation of the SPE electrolyte. The RHT activation approach successfully enables the ambient temperature operation of the SPE-based ASSLBs. The hot-press activation presents a highly efficient and cost-effective method for this process. This technique reduces the activation time from several days to just 3 hours, leading to significantly savings in time and energy cost. Additionally, the hot-press activation requires only a brief period (3 hours) at very low pressure (e.g., <0.5 MPa) and temperature (e.g., <100° C.), with minimal equipment needs, making it well-suited for large-scale or commercial applications.

The present disclosure describes an effective activation method that significantly enhances SPE properties and the ambient temperature performance of SPE-based all-solid-state batteries. As established in examples disclosed herein, elevated temperature and pressure markedly reduces the boundary resistance of the SPE, as well as the interfacial contact resistances of Li|SPE and cathode|SPE, thereby decreasing overall cell resistance and enabling ambient temperature operation. Among the entire Li-ion transport pathways in an SPE-based all-solid-state battery, the Li|SPE interface is identified as the most dominant factor in determining overall cell resistance. The method disclosed herein induces both grain amorphization and boundary merging and leads to significant resistance reduction of the PEO-LiTFSI electrolyte thereby achieving a balance between specific capacity and cell cycling. The activation method of the present disclosure enables operation of all-solid-state batteries, partiuclarly LFP batteries at room temperature, enhancing cell performance with a reversible capacity of 140 mAh g⁻¹ for 200 cycles in representative aspects.

In view of the many possible embodiments to which the principles of the present disclosure may be applied, it should be recognized that the illustrated embodiments are only preferred examples of the disclosure and should not be taken as limiting the scope of the disclosure. Rather, the scope is defined by the following claims. We therefore claim as our invention all that comes within the scope and spirit of these claims.

We claim:

1. A method for activating a solid polymer electrolyte (SPE) for use in a solid-state polymer battery, the method comprising exposing the SPE to activating conditions selected from (i) heat and pressure, or (ii) sonication to produce an activated SPE, wherein the activated SPE exhibits a higher ambient temperature ionic conductivity than the SPE prior to activation.

2. The method of claim 1, wherein the activated SPE exhibits fewer crystalline phases and/or fewer grain boundaries than the SPE prior to activation.

3. The method of claim 2, wherein crystalline phases and/or grain boundaries of the activated SPE are evaluated using backscattered electron imaging, differential scanning calorimetry, or a combination thereof.

4. The method of claim 1, wherein the activated SPE exhibits increased interfacial contact with an electrode active material of the solid-state polymer battery relative to the SPE prior to activation.

5. The method of claim 4, wherein interfacial contact is evaluated by measuring resistance between the electrode active material and the SPE.

6. The method of claim 1, wherein exposing the SPE to activating conditions comprises heating the SPE at a temperature ranging from a temperature greater than 40° C. to a temperature of 100° C. and applying a pressure ranging from 0.1 MPa to 10 MPa.

7. The method of claim 6, wherein pressure is applied for a time period ranging from greater than or equal to 15 minutes.

8. The method of claim 1, wherein the SPE is present in combination with an electrode active material, an anode, a cathode, a membrane, a separator, or any combination thereof.

9. The method of claim 1, wherein the SPE is activated after introducing the SPE into a cell to first form the SPE-containing solid-state battery, and wherein the activating conditions are applied to the SPE-containing solid-state battery.

10. The method of claim 9, wherein the SPE-containing solid-state battery comprising the activated SPE exhibits a specific capacity that is greater than or equal to 100 mAh/g after 100 charge-discharge cycles when operated at ambient temperature or lower.

11. The method of claim 1, wherein heating comprises using elevated temperature or microwaves.

12. The method of claim 1, wherein the SPE further comprises an additive, wherein the additive comprises a metal oxide, a metal sulfide, a metal halide, or a combination thereof.

13. The method of claim 12, wherein the SPE comprises the additive in an amount ranging from 1 wt. % to 80 wt. %.

14. The method of claim 1, wherein the SPE is provided as a coating layer on an electrode active material.

15. An all-solid-state polymer battery, comprising:
a cathode;
an anode; and
an activated solid polymer electrolyte (SPE), wherein the activated SPE has been activated according to the method of claim 1.

16. The polymer-containing solid-state battery of claim 15, wherein (i) the activated SPE exhibits fewer crystalline phases and/or fewer grain boundaries than an SPE that has not been activated; and/or (ii) the activated SPE exhibits increased interfacial contact with an electrode active material of the polymer electrolyte solid-state battery relative to an SPE that has not been activated.

17. The polymer-containing solid-state battery of claim 15, wherein the SPE-containing solid-state battery has an ambient temperature specific capacity of greater than or equal to 100 mAh/g after 100 charge-discharge cycles.

18. The polymer-containing solid-state battery of claim 15, wherein the SPE comprises a mixture of a polymer and an alkali salt, wherein the polymer is selected from polyethylene oxide, polyacrylonitrile, polymethyl methacrylate, polyvinylidene fluoride, polycarbonate; and the alkali salt is selected from lithium bis(trifluoromethane)sulfonimide, lithium perchlorate (LiClO₄), lithium hexafluorophosphate (LiPF₆), lithium bis(fluorosulfonyl)imide (LiCF₃SO₃) (LiFSI), lithium bis(pentafluoroethanesulfonyl)imide (Li(C₂F₅SO₂)₂N) (LiBETI), lithium trifluoromethanesulfonate (LiCF₃SO₃) (LiTf), lithium bis(oxalato)borate (LiB(C₂O₄)₂) (LiBOB), lithium difluoro (oxalato) borate (LiBF₂(C₂O₄)) (LiODFB), lithium nitrate (LiNO₃), lithium iodide (LiI), sodium perchlorate (NaClO₄), sodium bis(trifluoromethanesulfonyl)imide (NaTFSI), magnesium bis(trifluoromethanesulfonimide) (Mg(TFSI)₂), or a combination thereof.

19. A method for activating a solid polymer electrolyte (SPE) for use in a solid-state polymer battery, the method comprising:
exposing the SPE to a temperature ranging from a temperature higher than 40° C. to a temperature of 100° C. and a pressure ranging from 0.5 MPa to 10 MPa, to produce an activated SPE; and
allowing the SPE to cool to ambient temperature prior to operating any solid-state polymer to which the SPE is added,
wherein the activated SPE exhibits a higher ambient temperature ionic conductivity than the SPE prior to activation.

20. An activated solid polymer electrolyte (SPE) comprising an alkali salt and a polymer component, wherein the activated SPE is free of crystalline regions and that exhibits an ambient temperature ionic conductivity that is three to ten times higher than an ambient temperature ionic conductivity exhibited by an untreated SPE having the alkali salt and polymer component as the activated SPE.
